(19) United States
(12) Patent Application Publication
(10) Pub. No.: US 2026/0112953 A1
(43) Pub. Date: Apr. 23, 2026

(54) METHOD FOR MANUFACTURING MOTOR WITH HOUSING AND END PLATE

(71) Applicant: IHI Corporation, Tokyo (JP)

(72) Inventors: Kai IIJIMA, Tokyo (JP); Tatsumi INOMATA, Tokyo (JP); Tatsuya FUKUI, Tokyo (JP)

(21) Appl. No.: 19/428,308

(22) Filed: Dec. 22, 2025

Related U.S. Application Data
(63) Continuation of application No. PCT/JP2024/004409, filed on Feb. 8, 2024.

(30) Foreign Application Priority Data
Jun. 26, 2023 (JP) 2023-104032

(51) Int. Cl. H02K 15/14; H02K 1/14; H02K 3/18; H02K 5/04

(52) U.S. Cl. CPC H02K 15/14; H02K 1/14; H02K 3/18; H02K 5/04

(57) ABSTRACT

An example method for manufacturing a motor includes attaching an end plate to a housing accommodating a stator around which a coil is wound, the end plate including a first end plate through-hole and a second end plate through-hole. After attaching the end plate to the housing, a first amount of an uncured resin is injected into a stator arrangement region inside the housing, in which the stator and the coil are located, through the first end plate through-hole. Additionally, after attaching the end plate to the housing, the method includes injecting a second amount of the uncured resin into the stator arrangement region through the second end plate through-hole.

### CROSS-REFERENCE TO RELATED APPLICATIONS

This application is a continuation application of PCT Application No. PCT/JP2024/004409, filed on Feb. 8, 2024, which claims the benefit of priority from Japanese Patent Application No. 2023-104032, filed on Jun. 26, 2023. The entire contents of the above listed PCT and priority applications are incorporated herein by reference.

### BACKGROUND

### Field

The present disclosure relates to a method for manufacturing a motor and a motor.

### Description of the Related Art

Japanese Unexamined Patent Application Publication No. 2022-18465 discloses a method for manufacturing a PM motor. In this method, a coil is disposed on an inner diameter side of a stator core and then resin is injected in through a mold injecting port. Thereafter, the injected resin is cured by being heated or the like so that a mold resin layer covering the stator core and the coil is formed. Japanese Unexamined Patent Publication No. 2018-130026 and International Publication No. WO2021/200817 disclose techniques of fixing a magnet with resin.

### SUMMARY

In recent years, techniques for improving the output of a motor have been studied. In a case where the output of a motor is to be improved, a larger current is applied to a coil. As a result, the amount of heat generated by the coil increases and thus cooling the coil may be necessary. Therefore, it may be able to use resin, which is for waterproofing and rust prevention regarding the coil, as a heat path for extraction of heat from the coil.

Resin with high thermal conductivity may have a high viscosity in an uncured state. In a case where uncured resin is injected into a configuration in which a stator is disposed in a housing, it takes a long time for the resin to reach throughout a gap. In addition, in a case where resin having a short pot life is used, the resin may cure before filling is completed.

For example, in order to use the resin as a heat path, the resin may need to be in contact with both the coil and the housing that accommodates the coil. This is because, even if the resin is in contact with the coil, if it is not in contact with the housing, a gap between the resin and the housing serves as a thermal resistance. As a result, the resin may not function as a heat path.

Disclosed herein is an example method for manufacturing a motor includes an attachment step of attaching, to a housing accommodating a stator around which a coil is wound, an end plate provided with a first end plate through-hole and a second end plate through-hole, a first injection step of injecting, after the attachment step, uncured resin into a stator arrangement region of the housing accommodating the stator through the first end plate through-hole through which a first portion of the coil is visually observable from an outside of the housing, and a second injection step of injecting the uncured resin into the stator arrangement region of the housing through the second end plate through-hole through which a second portion of the coil, which is different from the first portion, is visually observable from the outside of the housing.

In the method, the uncured resin is injected after the end plate is attached. Then, the uncured resin is injected into the stator arrangement region by the step of injecting the uncured resin through the first end plate through-hole and the step of injecting the uncured resin through the second end plate through-hole different from the first end plate through-hole. In this case, a time it takes for the uncured resin to spread throughout the stator arrangement region can be shortened in comparison with a case where the uncured resin is injected at one position. Therefore, even in the case of a high-viscosity resin having high thermal conductivity, the time it takes for the uncured resin to spread throughout the stator arrangement region can be shortened. As a result, a motor from which heat is easily released to the outside can be produced in a short time.

In some examples, the first injection step and the second injection step may be repeated so that the uncured resin is exposed through at least one of the first end plate through-hole and the second end plate through-hole. When the uncured resin is in a state of being exposed through at least one of the first end plate through-hole and the second end plate through-hole, the uncured resin is in a state of being in contact with the rear surface of the end plate. Therefore, it may reliably form a path for transfer of heat from the coil to the end plate via the resin.

Additionally, an example method for manufacturing a motor is disclosed herein. The method for manufacturing the motor includes an injection step of injecting, through an opening of a housing accommodating a stator around which a coil is wound, uncured resin into a plurality of different portions in a stator arrangement region of the housing and an attachment step of attaching an end plate provided with a first end plate through-hole and a second end plate through-hole after the injection step. In the step of attaching the end plate, the end plate is pressed against a liquid surface of the uncured resin so that the uncured resin is exposed through the first end plate through-hole and/or the second end plate through-hole.

In some examples, the uncured resin is injected into the stator arrangement region at a plurality of positions different from each other. Therefore, a time it takes for the uncured resin to spread throughout the stator arrangement region can be shortened in comparison with a case where the uncured resin is injected at one position. In addition, the end plate is attached after the uncured resin is injected. When the end plate is attached, the end plate is pressed against the liquid surface of the uncured resin so that the uncured resin is exposed through the first end plate through-hole and/or the second end plate through-hole. The uncured resin exposed through the first end plate through-hole and/or the second end plate through-hole due to the pressing of the end plate means that the rear surface of the end plate is in contact with the uncured resin. Therefore, a motor from which heat is easily released to the outside can be produced in a short time.

In some examples, in the injection step, the uncured resin may be continuously injected while the housing and a device supplying the uncured resin are being relatively rotated around an axis of the housing. According to such a step as well, a time it takes for the uncured resin to spread throughout the stator arrangement region can be shortened.

In some examples, the injection step may include a step of injecting a predetermined amount of the uncured resin into a first portion of the coil, and a step of injecting a predetermined amount of the uncured resin into a second portion of the coil, which is different from the first portion. According to such a step as well, a time it takes for the uncured resin to spread throughout the stator arrangement region can be shortened.

Additionally, an example motor is disclosed herein. The motor includes a stator around which a coil is wound, a rotor enclosed by the stator and rotating together with a shaft, a housing which receives the stator and the rotor through a housing opening and forms a stator arrangement region for accommodating the received stator, an end plate attached to the housing opening, and a resin part filled in the stator arrangement region. The resin part is in contact with the coil and is in contact with the end plate. The end plate includes a plurality of end plate through-holes through which the resin part is exposed.

In some examples, the resin part may be in contact with the coil and is in contact with the end plate. With such a configuration, it may reliably form a path for transfer of heat from the coil to the end plate via the resin. As a result, heat may be released to the outside.

In some examples, an exposed surface of the resin part exposed through the end plate through-holes may be positioned between an opening edge on an end plate rear surface side and an opening edge on an end plate main surface side. With such a configuration, the resin part may be reliably in contact with the end plate rear surface.

In some examples, the end plate may include an annular inner peripheral cylindrical portion including an end plate shaft insertion hole through which the shaft is inserted, an annular outer peripheral cylindrical portion surrounding the inner peripheral cylindrical portion in a circumferential direction and having an inner diameter larger than an outer diameter of the inner peripheral cylindrical portion, and a plurality of connecting portions disposed at intervals around an axis of the shaft to connect an outer peripheral surface of the inner peripheral cylindrical portion to an inner peripheral surface of the outer peripheral cylindrical portion. The end plate through-hole may be a region interposed between a pair of the connecting portions adjacent to each other around the axis of the shaft. An end surface of the inner peripheral cylindrical portion may protrude from the connecting portions along an axial direction of the shaft. With such a structure, it may suppress adhesion of the uncured resin to the end surface of the inner peripheral cylindrical portion and it may use the end surface of the inner peripheral cylindrical portion as an installation surface for a component.

### BRIEF DESCRIPTION OF THE DRAWINGS

FIG. 1 is a cross-sectional view illustrating an example motor.

FIG. 2 is a cross-sectional perspective view illustrating a part of an end plate that the motor illustrated in FIG. 1 includes.

FIG. 3 is a front view of the motor illustrated in FIG. 1.

FIG. 4A is a cross-sectional view illustrating an example exposed surface of a resin part.

FIG. 4B is a cross-sectional view illustrating an example exposed surface of a resin part exposed surface.

FIG. 5 is a flowchart of a first method for manufacturing a motor.

FIG. 6A is a view illustrating an operation of accommodating a motor assembly into a vacuum chamber.

FIG. 6B is a view illustrating an operation of injecting uncured resin through a first end plate through-hole.

FIG. 7A is a view illustrating an operation of injecting uncured resin through a second end plate through-hole.

FIG. 7B is a view illustrating a state where it has been determined that the resin part exposed surface of an uncured resin material has reached a prescribed position.

FIG. 8 is a flowchart of an example method for manufacturing a motor.

FIG. 9 is a view illustrating examples of a first coil portion, a second coil portion, and a third coil portion.

### DETAILED DESCRIPTION

In the following description, with reference to the drawings, the same reference numbers are assigned to the same components or to similar components having the same function, and overlapping description is omitted.

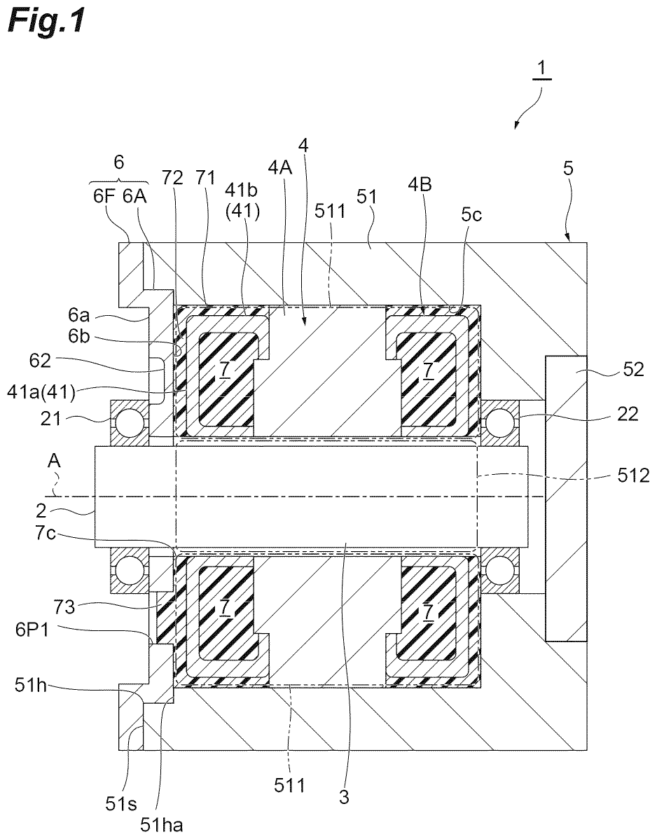

FIG. 1 is a cross-sectional view showing the structure of a motor 1 of the present disclosure. The motor 1 is used, for example, in a supercharger for a vehicle. The motor 1 applies torque to a shaft 2 to compensate for insufficient torque in a case where the torque of the shaft 2 is insufficient like when the vehicle is accelerated. In this case, an impeller is attached to an end of the shaft 2.

The motor 1 is, for example, a brushless alternating current motor. The motor 1 includes the shaft 2, a motor rotor 3, a motor stator 4, a housing 5, and an end plate 6. A battery of the vehicle can be used as a drive source of the motor 1. At the time of deceleration of the vehicle, the motor 1 may perform regenerative power generation by using rotational energy of the motor rotor 3. The motor 1 can cope with high-speed rotation (for example, 100,000 to 200,000 rpm) of the shaft 2.

The motor rotor 3, which is a so-called rotor, is disposed between a pair of bearings 21 and 22 provided along a direction along an axis A. A main element constituting the motor rotor 3 is a cylindrical magnet. The motor rotor 3 may include an element for transmitting, to the shaft 2, torque acting on the magnet. For example, the motor rotor 3 may include end rings disposed at both ends of the cylindrical magnet or an armoring and the like covering an outer peripheral surface of the magnet.

The motor stator 4, which is a so-called stator, is accommodated in the housing 5. The motor stator 4 is disposed to surround the motor rotor 3 in a circumferential direction. The motor stator 4 includes a core 4A and a coil 4B. As a result of supply of a current to the coil 4B, the coil 4B generates a magnetic field. A force in the circumferential direction acts on the magnet of the motor rotor 3 due to the magnetic field. As a result, torque is applied to the shaft 2.

The housing 5 forms a region in which the motor rotor 3 and the motor stator 4 are accommodated. The housing 5, which is a tubular member, includes a tubular portion 51 and a bottom 52. One end of the housing 5 in a direction, in which the axis of the shaft 2 extends, is open so that components such as the motor rotor 3 and the motor stator 4 are accommodated. The housing 5 includes a housing opening 51h. The housing 5 includes structures for exhibiting a function of the motor 1, such as an electrode portion for applying a current to the coil 4B.

A motor stator arrangement region 511 (a stator arrangement region) and a motor rotor arrangement region 512 are formed in the housing 5. The motor stator arrangement region 511 is a region enclosed by the tubular portion 51. The motor stator 4 having a cylindrical shape is fixed to a tubular portion inner peripheral surface.

The housing opening 51h is blocked by the end plate 6. The expression “to close off” means to maintain the positions of constituent components accommodated in the housing 5. The end plate 6 having a disk-like shape is fixed to an end of the housing 5. The bearing 21 is fixed to the end plate 6.

### End Plate

The shape of the end plate 6 will be described in more detail. The shape of the end plate 6 is substantially a disk. The end plate 6 includes an end plate main body 6A and an end plate flange 6F. The end plate main body 6A is fitted into an opening recess 51ha of the housing 5. The end plate flange 6F abuts a housing opening end surface 51s. The end plate flange 6F is provided with several bolt through-holes. Bolts inserted into the bolt through-holes are screwed into screw holes provided at the housing opening end surface 51s. As a result, the end plate 6 is fixed to the housing 5.

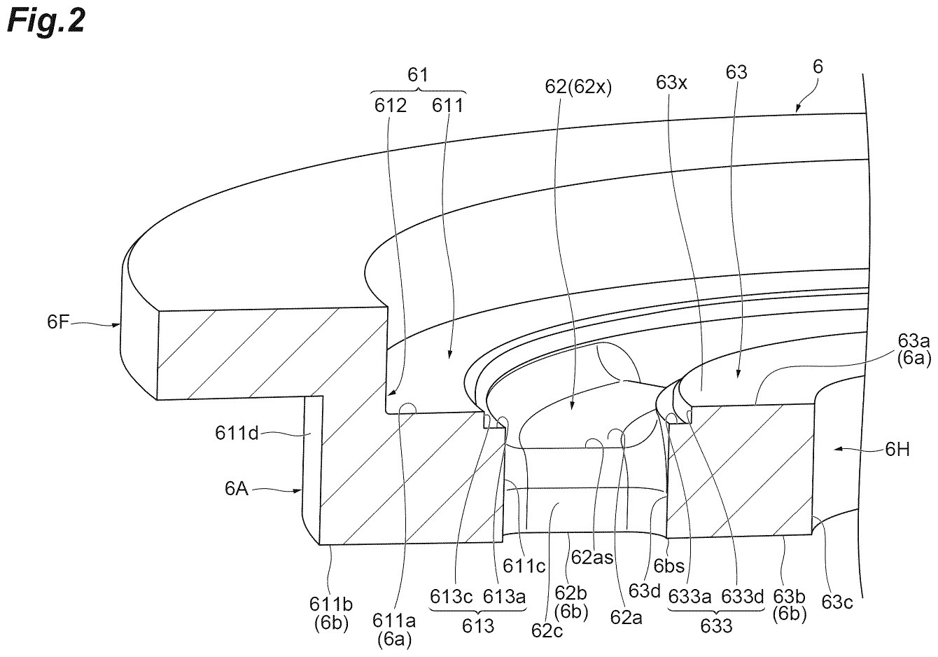

As shown in FIG. 2, the end plate main body 6A includes an outer peripheral cylindrical portion 61, connecting portions (e.g., spokes 62), and an inner peripheral cylindrical portion 63. The outer peripheral cylindrical portion 61 is a portion integrated with the end plate flange 6F described above. The outer peripheral cylindrical portion 61 includes an outer peripheral annular portion 611 and an outer peripheral upright portion 612. The outer peripheral upright portion 612 extends upright along the direction along the axis A from an outer peripheral annular portion main surface 611a of the outer peripheral annular portion 611. The end plate flange 6F extends in a radial direction from an outer peripheral upright portion outer peripheral surface 611d. The outer peripheral annular portion main surface 611a functions as an installation surface for mounting of another device to the motor 1. The outer peripheral annular portion main surface 611a may be defined as a part of a main surface (e.g., end plate main surface 6a).

An outer peripheral step portion 613 is formed at a corner portion between the outer peripheral annular portion main surface 611a and an outer peripheral annular portion inner peripheral surface 611c. The outer peripheral step portion 613 includes an outer peripheral step main surface 613a and an outer peripheral step inner peripheral surface 613c. The outer peripheral step main surface 613a is at a position recessed from the outer peripheral annular portion main surface 611a. The inner diameter of the outer peripheral step inner peripheral surface 613c is larger than that of the outer peripheral annular portion inner peripheral surface 611c.

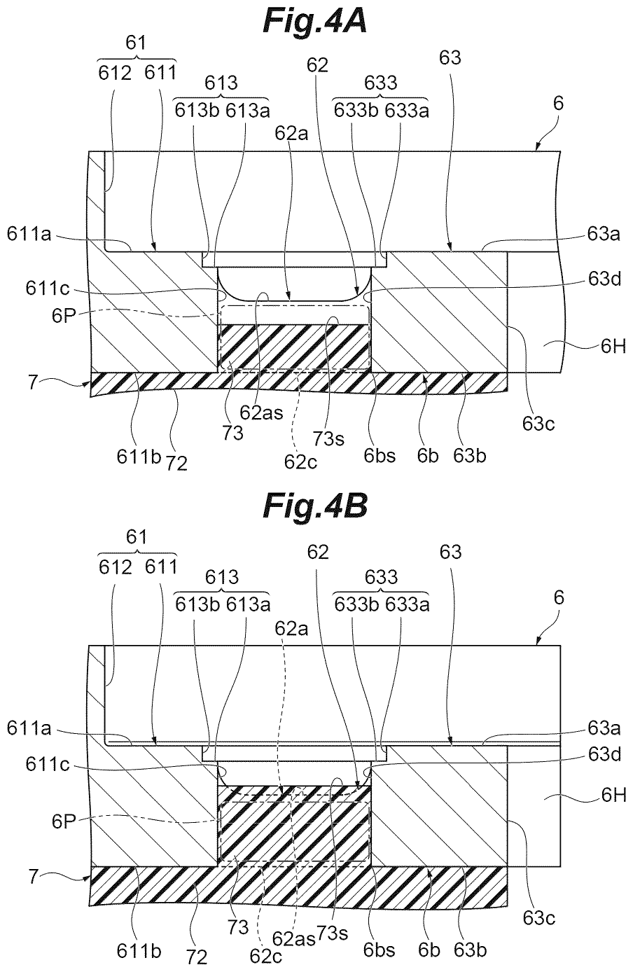

A resin part 7 is in contact with an outer peripheral annular portion rear surface 611b (refer to FIG. 4A). Therefore, the outer peripheral annular portion rear surface 611b constitutes a part of a heat path. The outer peripheral annular portion rear surface 611b may be defined as a part of a rear surface (e.g., end plate rear surface 6b). The spokes 62 are connected to a part of the outer peripheral annular portion inner peripheral surface 611c. The end plate rear surface 6b faces the housing 5. The end plate main surface 6a is located opposite the end plate rear surface 6b.

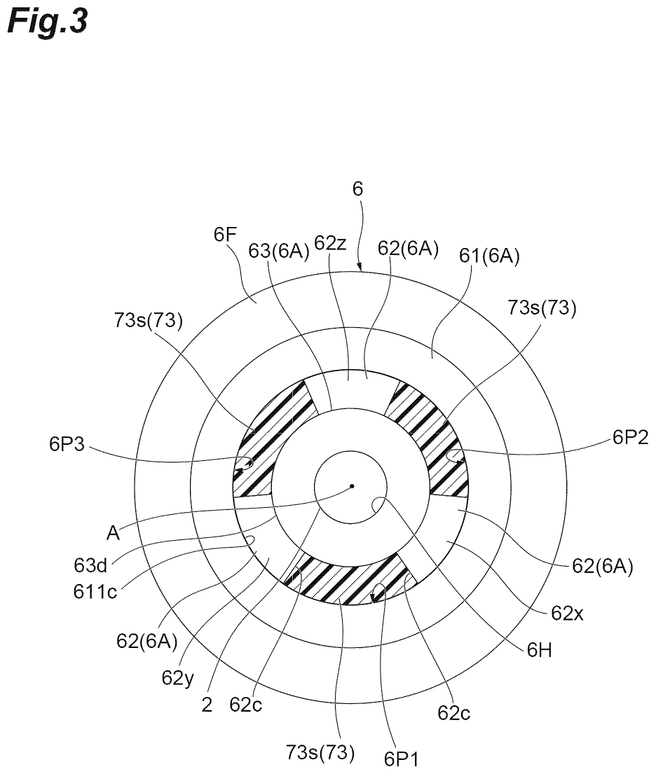

The spokes 62 connect the inner peripheral cylindrical portion 63 to the outer peripheral cylindrical portion 61. In an example shown in FIG. 3, the end plate 6 includes three spokes 62 (e.g., first connecting portion 62x, second connecting portion 62y, third connecting portion 62z). The three spokes 62 may be disposed at equal intervals around the axis A.

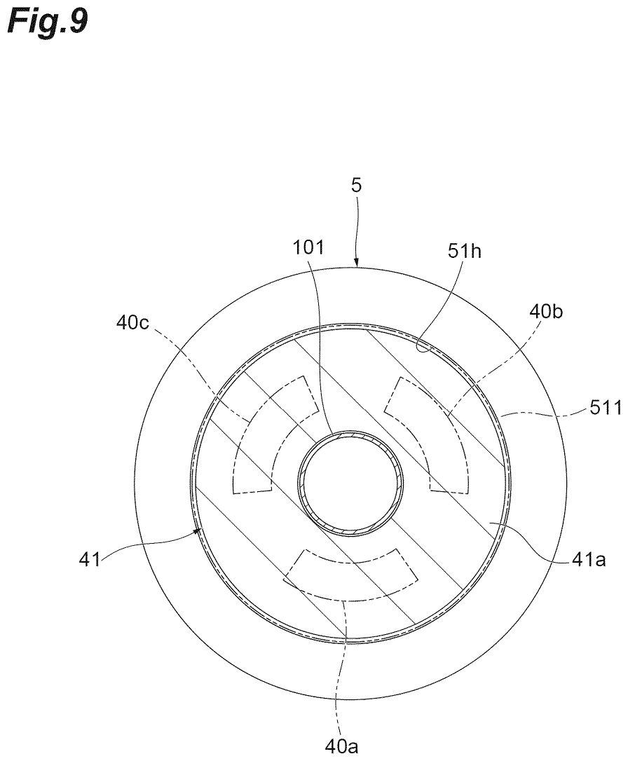

As shown in FIG. 3, spaces between the spokes 62 adjacent to each other are defined as end plate through-holes 6P1, 6P2, and 6P3. For example, the end plate through-hole 6P1 may be an opening through which a first coil portion (e.g., first portion 40a), which will be described later, can be visually recognized. Similarly, the end plate through-holes 6P2 and 6P3 may be openings through which a second coil portion (e.g., second portion 40b) and a third coil portion (e.g., third portion 40c) can be visually recognized, respectively. The first portion 40a, the second portion 40b and the third portion 40c are illustrated in FIG. 9.

In the example shown in FIG. 3, the end plate 6 includes three end plate through-holes 6P1, 6P2, and 6P3. The end plate through-holes 6P1, 6P2, and 6P3 can be defined as regions enclosed by a part of the outer peripheral annular portion inner peripheral surface 611c, a part of an inner peripheral cylindrical portion outer peripheral surface 63d, and spoke peripheral end surfaces 62c. Openings of the end plate through-holes 6P1, 6P2, and 6P3 that are on the end plate main surface 6a side may be defined by edges included in the spoke peripheral end surfaces 62c. The length of the end plate through-holes 6P along the axis A may be defined as a length from the end plate rear surface 6b to spoke main surfaces 62a.

As shown in FIG. 2, the spokes 62 extend from the outer peripheral annular portion inner peripheral surface 611c to the inner peripheral cylindrical portion outer peripheral surface 63d. The spoke main surfaces 62a are not so-called flush with the outer peripheral annular portion main surface 611a. For example, when comparison is performed in terms of height with respect to the spoke rear surfaces 62b, it can be found that the height of the spoke main surfaces 62a is lower than the height of the outer peripheral annular portion main surface 611a. The spoke rear surfaces 62b are flush with the outer peripheral annular portion rear surface 611b. As with the outer peripheral annular portion rear surface 611b, the spoke rear surfaces 62b are parts of the end plate rear surface 6b and constitute a part of the heat path.

The inner peripheral cylindrical portion 63 includes an inner peripheral cylindrical portion main surface 63a, an inner peripheral cylindrical portion rear surface 63b, an inner peripheral cylindrical portion inner peripheral surface 63c, and the inner peripheral cylindrical portion outer peripheral surface 63d. The bearing 21 is disposed on the inner peripheral cylindrical portion main surface 63a. The inner peripheral cylindrical portion main surface 63a is a bearing mounting surface. The inner peripheral cylindrical portion main surface 63a may be defined as a part of the end plate main surface 6a.

The inner peripheral cylindrical portion rear surface 63b is flush with the outer peripheral annular portion rear surface 611b and the spoke rear surfaces 62b. As with the outer peripheral annular portion rear surface 611b and the spoke rear surfaces 62b, the inner peripheral cylindrical portion rear surface 63b is a part of the end plate rear surface 6b and constitutes a part of the heat path. As described above, the spokes 62 are connected to a part of the inner peripheral cylindrical portion outer peripheral surface 63d. Other parts of the inner peripheral cylindrical portion outer peripheral surface 63d are surfaces that define the end plate through-holes 6P1, 6P2, and 6P3. The inner peripheral cylindrical portion inner peripheral surface 63c defines an end plate shaft insertion hole 6H through which the shaft 2 is inserted.

An inner peripheral step portion 633 is also formed at a corner portion between the inner peripheral cylindrical portion main surface 63a and the inner peripheral cylindrical portion inner peripheral surface 63c. The inner peripheral step portion 633 includes an inner peripheral step main surface 633a and an inner peripheral step outer peripheral surface 633d. The inner peripheral step main surface 633a is at a position recessed from the inner peripheral cylindrical portion main surface 63a. The outer diameter of the inner peripheral step outer peripheral surface 633d is larger than that of the inner peripheral cylindrical portion outer peripheral surface 63d. The inner peripheral step portion 633 can also be used as a portion for abutment of a masking jig in a method for manufacturing a motor, in cooperation with the outer peripheral step portion 613.

### Resin Part

As shown in FIG. 1, the motor 1 further includes a resin part 7. The resin part 7 is filled in the motor stator arrangement region 511 in which the motor stator 4 is disposed. The resin part 7 covers the coil 4B. The resin part 7 covers coil ends 41 that protrude from end surfaces of the core 4A. According to such a resin part 7, the coil 4B does not come into direct contact with air. That is, the resin part 7 provides a waterproof function that protects the coil 4B from moisture, and provides a rust prevention function that suppresses the generation of rust on the coil 4B.

The resin part 7 is filled in the motor stator arrangement region 511. The resin part 7 does not fill the motor rotor arrangement region 512 in which the motor rotor 3 is disposed. Therefore, the resin part 7 may form a resin part inner peripheral surface 7c facing the motor rotor 3.

The resin part 7 exhibits a function as a heat path for releasing heat generated in the coil 4B to the housing 5 and the end plate 6. The resin part 7 includes a portion 71 that filled between coil end outer peripheral surfaces 41b and a housing inner peripheral surface 5c. The portion 71 is in contact with the coil end outer peripheral surfaces 41b and is in contact with the housing inner peripheral surface 5c as well. As a result, thermal resistance from the coil ends 41 to the housing 5 is dominated by the resin part 7. In a case where a material having high thermal conductivity is used for the resin part 7, heat can be favorably released from the coil ends 41 to the housing 5.

Examples of such resin include two-component curable epoxy resin.

The resin part 7 includes a portion 72 that is filled between a coil end end surface 41a and the end plate rear surface 6b. The portion 72 is in contact with the coil end end surface 41a and is in contact with the end plate rear surface 6b as well. As a result, as with the description made above, thermal resistance from the coil ends 41 to the end plate 6 is dominated by the resin part 7.

As shown in FIG. 4A, the resin part 7 further includes a portion 73 that is filled in the end plate through-holes 6P. Surfaces of the resin part 7 exposed through the end plate through-holes 6P will be referred to as resin part exposed surfaces 73s. The resin part exposed surface 73s shown in FIG. 4A does not leak out from the end plate through-hole 6P. It will be assumed that an upper end of the end plate through-hole 6P is defined by an opening edge 62as (an opening edge on an end plate main surface side) of the spoke main surface 62a. In addition, it will be assumed that a lower end of the end plate through-hole 6P is defined by an opening edge 6bs (an opening edge on an end plate rear surface side) of the end plate rear surface 6b. According to this assumption, the resin part exposed surface 73s is positioned between the spoke main surface 62a and the end plate rear surface 6b. According to the position of the resin part exposed surface 73s, the inner peripheral cylindrical portion main surface 63a protrudes from the resin part exposed surface 73s. Therefore, the resin part 7 does not adhere to the inner peripheral cylindrical portion main surface 63a. As a result, the bearing 21 can be favorably attached to the inner peripheral cylindrical portion main surface 63a.

The position of the resin part exposed surface 73s may be on the motor stator 4 side with respect to at least the inner peripheral cylindrical portion main surface 63a. For example, as shown in FIG. 4B, the resin part exposed surface 73s may be higher than the spoke main surface 62a and may cover the spoke main surface 62a. Even in such a case, the position of the resin part exposed surface 73s is lower than the position of the outer peripheral annular portion main surface 611a and/or the inner peripheral cylindrical portion main surface 63a. Therefore, the resin part 7 does not adhere to the outer peripheral annular portion main surface 611a and/or the inner peripheral cylindrical portion main surface 63a. As a result, components such as the bearing 21 can be favorably attached to the outer peripheral annular portion main surface 611a and/or the inner peripheral cylindrical portion main surface 63a.

Next, a method for manufacturing the motor 1 will be described. The motor 1 can be manufactured by using either of two methods described below.

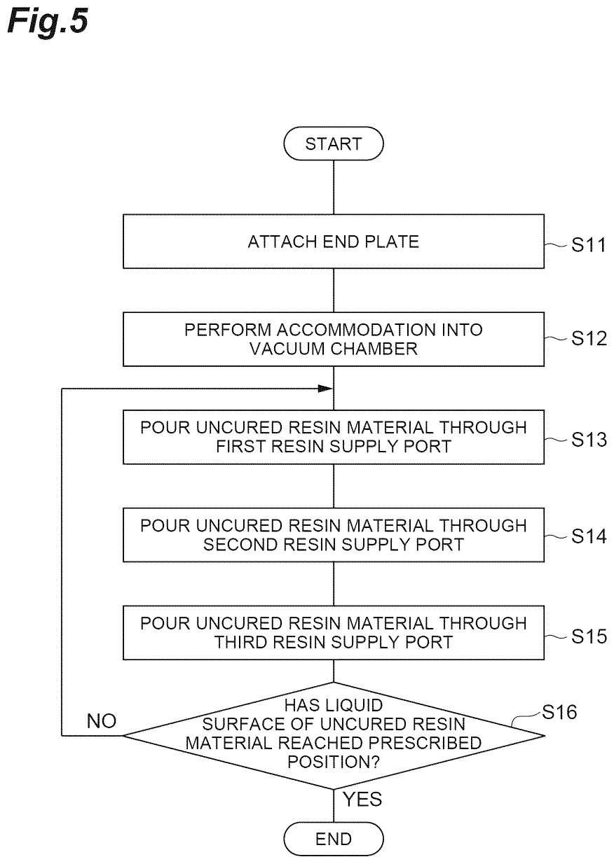

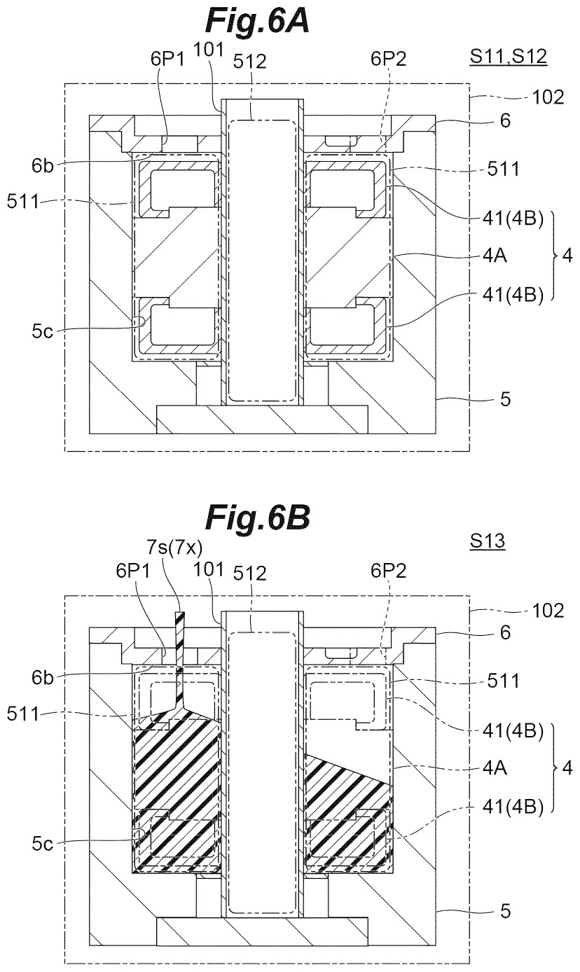

FIG. 5 is a diagram showing some steps (operations) in an example method for manufacturing a motor. First, the motor stator 4 is disposed in the housing 5. Next, a cylindrical member 101 (refer to FIG. 6A) is disposed in a region corresponding to the motor rotor arrangement region 512. This is to prevent uncured resin from being filled in the motor rotor arrangement region 512 when the step of filling with the uncured resin is performed. The end plate 6 is fixed to the housing 5 (S11: refer to FIG. 6A). In the following description, the motor 1 that is being assembled in each of the production steps of the motor 1 will be referred to, for convenience of explanation, as a “motor assembly.”

Next, the motor assembly is accommodated into a vacuum chamber 102 (S12: refer to FIG. 6A). In the method illustrated in FIG. 5, so-called vacuum filling is used to perform filling with uncured resin.

Next, the first amount 7x of the uncured resin 7s is injected through the first end plate through-hole 6P1 (S13: refer to FIG. 6B). In this case, the motor assembly may be heated to a predetermined temperature so that the fluidity of the uncured resin 7s is maintained. After the predetermined amount of the uncured resin 7s is injected, the injecting of the uncured resin 7s is stopped.

In this example, the uncured resin 7s reaches the coil end 41 through the first end plate through-hole 6P1 and then flows to the coil end 41 on the opposite side. Because the viscosity of the uncured resin 7s is high, the injected uncured resin 7s requires a considerable time to enter a steady state. The “steady state” herein means that the inclined liquid surface of the uncured resin 7s is made horizontal.

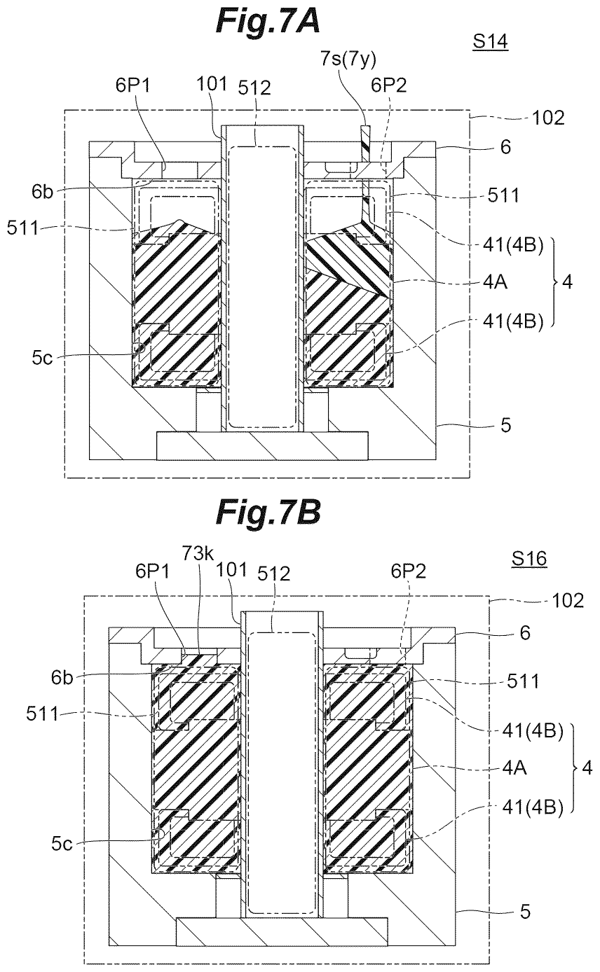

Next, before the uncured resin 7s injected through the first end plate through-hole 6P1 enters the steady state, the injecting of the second amount 7y of the uncured resin 7s is started through the second end plate through-hole 6P2 (S14: refer to FIG. 7A). According to step S14, a state shown in FIG. 7A is achieved. The uncured resin 7s injected through the second end plate through-hole 6P2 flows into a region that the uncured resin 7s injected through the first end plate through-hole 6P1 has not yet reached. Then, after a predetermined amount of the uncured resin 7s is injected, the injecting of the uncured resin 7s is stopped.

Similarly, before the uncured resin 7s injected through the second end plate through-hole 6P2 enters the steady state, the injecting of the uncured resin 7s is started through the third end plate through-hole 6P3 (S15).

After step S15, it is checked whether or not the liquid surface of the uncured resin 7s, which has been injected through each of the end plate through-holes 6P1, 6P2, and 6P3 has reached a prescribed position (S16). This check may be performed by visually observing the position of a liquid surface 73k of the uncured resin 7s through the end plate through-holes 6P1, 6P2, and 6P3. For example, it may be determined that the liquid surface 73k of the uncured resin 7s has reached the prescribed position on a condition that the liquid surface 73k of the uncured resin 7s has reached each of the end plate through-holes 6P1, 6P2, and 6P3 as shown in FIG. 7B.

In a case where it is determined that the liquid surface 73k of the uncured resin 7s has reached the prescribed position, the injecting of the uncured resin 7s is ended. Then, the motor assembly is heated at a predetermined temperature. As a result, the uncured resin 7s becomes the solidified resin part 7. Thereafter, a step of attaching the motor rotor 3 and the bearing 21 is performed to obtain the motor 1.

In a case where it is not determined that the liquid surface 73k of the uncured resin 7s has reached the prescribed position, the uncured resin 7s is injected again through the first end plate through-hole 6P1 (S13).

Whether or not the liquid surface 73k of the uncured resin 7s has reached the prescribed position may be constantly checked during each of steps S13 to S15 in which the uncured resin 7s is injected. In addition, in a case where it is determined that the liquid surface 73k of the uncured resin 7s has reached the prescribed position, the process may proceed to the next production step after the repetition of steps S13 to S15 in which the uncured resin 7s is injected is stopped.

According to the example method illustrated in FIG. 5, the uncured resin 7s is injected until it is confirmed that the liquid surface of the uncured resin 7s has reached each of the end plate through-holes 6P1, 6P2, and 6P3. The expression “the uncured resin 7s has reached the end plate through-holes 6P1, 6P2, and 6P3” means that filling with the uncured resin 7s has been performed to such a degree that the uncured resin 7s comes into contact with the end plate rear surface 6b. Therefore, the resin part 7 can be reliably formed between the coil end 41 and the end plate rear surface 6b.

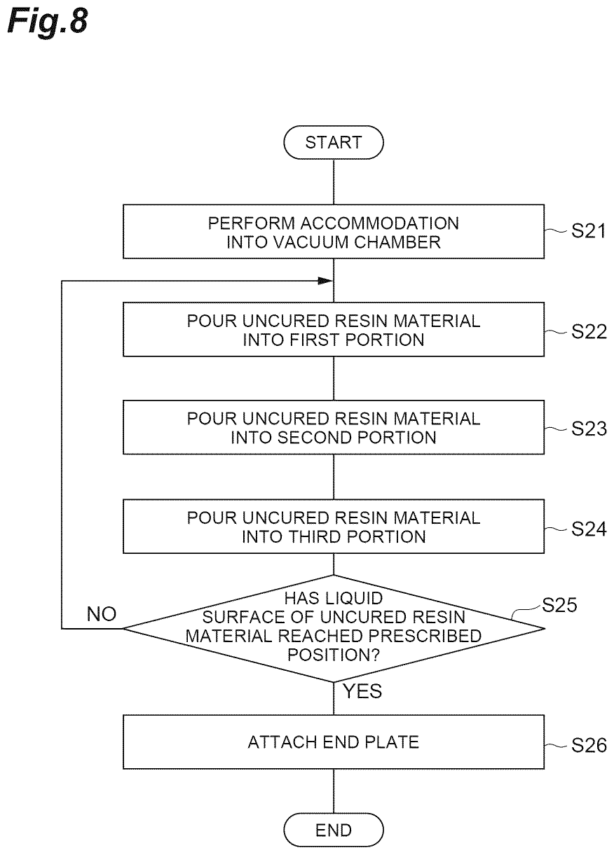

In the example method illustrated in FIG. 5, an uncured resin 7s is injected (S13, S14, S15) after the end plate 6 is attached to the housing 5 (S11). In an example method for manufacturing a motor illustrated in FIG. 8, the end plate 6 is attached after the uncured resin 7s is injected.

FIG. 8 is a diagram showing some steps (operations) included in the example method for manufacturing a motor. First, the motor stator 4 is disposed in the housing 5. Next, the cylindrical member 101 is disposed in a region corresponding to the motor rotor arrangement region 512. Then, the motor assembly is accommodated into the vacuum chamber 102 (S21). In this case, the end plate 6 is not attached to the motor assembly.

Next, the uncured resin 7s is injected into the first portion 40a (refer to FIG. 9) (S22). The first portion 40a is any portion in the motor stator arrangement region 511 exposed through the housing opening 51h (refer to FIG. 9). Then, after a predetermined amount of the uncured resin 7s is injected, the injecting of the uncured resin 7s is stopped.

Next, the uncured resin 7s is injected into a second portion 40b (refer to FIG. 9) (S23). The second portion 40b is any portion in the motor stator arrangement region 511 exposed through the housing opening 51h and is a portion different from the first portion 40a. Then, after a predetermined amount of the uncured resin 7s is injected, the injecting of the uncured resin 7s is stopped.

Then, the uncured resin 7s is injected into a third portion 40c (refer to FIG. 9) (S24). The third portion 40c is any portion in the motor stator arrangement region 511 exposed through the housing opening 51h and is a portion different from the first portion 40a and the second portion 40b. Then, after a predetermined amount of the uncured resin 7s is injected, the injecting of the uncured resin 7s is stopped.

Note that in the above description, the injecting of the uncured resin 7s is stopped after the predetermined amount of the uncured resin 7s is injected into each portion in steps S22, S23, and S24. For example, the process may proceed to step S23 without stopping of the injecting of the uncured resin 7s in step S22. For example, the motor assembly may be rotated by a predetermined angle while the uncured resin 7s from a supply device is being injected so that the position of injecting from the supply device is changed from the first portion 40a to the second portion 40b. The supply device of the uncured resin 7s may be moved in a state where the motor assembly is fixed so that the position of injecting is changed from the first portion 40a to the second portion 40b.

After step S24, it is checked whether or not the liquid surface of the uncured resin 7s has reached the prescribed position (S25). This check may be made by visually observing the position of the liquid surface of the resin through the housing opening 51h.

In a case where it is determined that the liquid surface of the uncured resin 7s has reached the prescribed position, the injecting of the uncured resin 7s is ended. Then, the motor assembly is extracted from the vacuum chamber 102. Next, the end plate 6 is fixed to the housing 5 (S26). In this case, the uncured resin 7s has reached the opening recess 51ha of the housing 5. In addition, in a case where the end plate 6 is attached to the housing opening 51h, the uncured resin 7s that has reached the opening recess 51ha flows into the end plate through-holes 6P1, 6P2, and 6P3 in response to the pressure received from the end plate 6. The pressure received by the uncured resin 7s is generated because the end plate rear surface 6b is in contact with the uncured resin 7s. That is, when the end plate 6 is attached, the fact that the uncured resin 7s flows into the end plate through-holes 6P1, 6P2, and 6P3 means that there is no gap between the end plate rear surface 6b and the uncured resin 7s. The end plate rear surface 6b is in contact with the uncured resin 7s. Then, the motor assembly is heated at a predetermined temperature. Thereafter, the step of attaching the motor rotor 3 and the bearing 21 is performed to obtain the motor 1.

In a case where it is not determined that the liquid surface of the uncured resin 7s has reached the prescribed position, the resin is injected again from the first portion 40a (S22).

Similarly to the first method for manufacturing a motor, it may always be checked during each of steps S22, S23, and S24 in which the uncured resin is injected.

An example motor stator includes a resin part encapsulating the entire motor assembly including a core and a wound coil, for the purpose of ensuring waterproofing and rust prevention of the coil. Furthermore, for a motor aiming at a high output density, a structure may be adopted in which resin having high thermal conductivity is used and a gap between a stator and a motor housing provided with a water-cooling structure is filled with the resin so that heat generated by a coil is transferred to a core or a case. The resin is caused to flow into an opening of the case after the case and the stator are assembled. Then, the temperature of the case as a whole is raised so that the resin is cured. Two-component curable epoxy resin is used as the resin in many cases.

Examples of a method of providing the opening include a step of injecting resin before an end plate on one side is mounted and mounting the end plate after the injected resin is cured. In addition, the examples of a method of providing the opening also include a method of forming a hole in the end plate beforehand.

Since the end plate is mounted after the cast resin is cured, a gap may be formed between the liquid surface of the cured resin and the end plate. In the case of an electric supercharger, a resin having high thermal conductivity may be used. However, such resin has extremely high viscosity and is likely to include air bubbles when the resin is injected. Therefore, casting is performed in a vacuum chamber in order to minimize defects after curing. As a result, the liquid surface is foaming during casting of the resin. Therefore, it may be difficult to strictly manage the injecting height. Therefore, a predetermined gap (at least 2 to 3 mm) between the end plate and the cured resin may be needed. In addition, it may be needed to secure a static settling time (a liquid surface leveling time) for making the liquid surface even, and the casting may require an extremely long time. For this reason, In some motors, a gap may be present between the cured resin and the end plate, and condensation may cause water to accumulate in the gap. As a result, a decrease in insulation may occur due to penetration of water. Additionally, the heat of the coil may not be able to be dissipated from the end surface.

On the other hand, the examples illustrated in FIGS. 5 and 8, may allow the motor to be manufactured without forming the gap described above.

The example method for manufacturing the motor 1 illustrated in FIG. 5, includes an attachment step (S11) of attaching, to the housing 5 that accommodates the motor stator 4 around which the coil 4B is wound, the end plate 6 provided with the first end plate through-hole 6P1 and the second end plate through-hole 6P2, a first injection step (S13), after the attachment step (S11), of injecting uncured resin 7s into the motor rotor arrangement region 512 of the housing 5 accommodating the motor stator 4, from outside the housing 5, through the first end plate through-hole 6P1 through which a first portion 40a of the coil 4B is visually observable, and a second injection step (S14) of injecting the uncured resin 7s into the motor rotor arrangement region 512 of the housing 5, from outside the housing 5, through the second end plate through-hole 6P2 through which a second portion 40b of the coil 4B, different from the first portion 40a, is visually observable.

In the example method for manufacturing the motor 1, the uncured resin 7s is injected after the end plate 6 is attached. Then, the uncured resin 7s is injected into the motor rotor arrangement region 512 through the step (S13) of injecting the uncured resin 7s through the first end plate through-hole 6P1 and the step (S14) of injecting the uncured resin 7s through the second end plate through-hole 6P2 different from the first end plate through-hole 6P1. In this case, a time it takes for the uncured resin 7s to spread throughout the motor rotor arrangement region 512 can be shortened in comparison with a case where the uncured resin 7s is injected at one position. Therefore, even in the case of the high-viscosity resin part 7 having high thermal conductivity, a time it takes for the uncured resin 7s to spread throughout the motor rotor arrangement region 512 can be shortened. As a result, the motor 1 from which heat is easily released to the outside can be produced in a short time.

In the example method for manufacturing the motor 1, the first injection step (S13) and the second injection step (S14) are repeated so that the uncured resin 7s is exposed through the first end plate through-hole 6P1 and the second end plate through-hole 6P2. When the uncured resin 7s is in a state of being exposed through the first end plate through-hole 6P1 and the second end plate through-hole 6P2, the uncured resin 7s is in a state of being in contact with the end plate rear surface 6b. Therefore, it may reliably form a path for transfer of heat from the coil 4B to the end plate 6 via the resin part 7.

In short, in the method for manufacturing a motor, a plurality of openings are provided in the end plate 6. As described above, the number of the openings depends on the size of the motor 1, but may be about three. After injecting the uncured resin 7s through the first end plate through-hole 6P1, by injecting the uncured resin 7s through the next, second end plate through-hole 6P2 during the liquid surface leveling time, the leveling time can be reduced. Therefore, the efficiency of manufacturing the motor is improved.

In the example method for manufacturing a motor, it may perform filling with a high-viscosity resin without gaps while maintaining a realistic takt time. The size of the end plate through-holes 6P, which are openings, can be made smaller. Therefore, it may maintain the mounting rigidity of the bearing housing provided at the end plate 6 and the heat dissipation capability from the end plate 6 side.

In the example where the uncured resin 7s is injected through the first end plate through-hole 6P1, the liquid surface 73k of the uncured resin 7s is leveled toward the second end plate through-hole 6P2 and the third end plate through-hole 6P3. Next, the uncured resin 7s is injected through the second end plate through-hole 6P2 when the liquid surface 73k becomes unbalanced. It may perform liquid casting while keeping the liquid surface 73k uniform by repeating such a process. It may reduce the risk of overflowing of the uncured resin 7s by minimizing the time for which the uncured resin 7s is dropped onto the spokes 62 connecting the end plate through-holes 6P.

The example method for manufacturing the motor 1 illustrated in FIG. 8, includes an injection step (S22, S23, and S24) in which uncured resin 7s is injected, through an opening of the housing 5 that accommodates the motor stator 4 around which the coil 4B is wound, into mutually different first portion 40a, second portion 40b, and third portion 40c in the motor rotor arrangement region 512 of the housing 5, and an attachment step (S26) in which, after the injection step (S22, S23, and S24), an end plate 6 provided with a first end plate through-hole 6P1 and a second end plate through-hole 6P2 is attached. In the step (S28) of attaching the end plate 6, by pressing the end plate 6 against the liquid surface of the uncured resin 7s, the uncured resin 7s is exposed from the first end plate through-hole 6P1 and/or the second end plate through-hole 6P2.

In the example method for manufacturing the motor 1, the uncured resin 7s is injected into the motor rotor arrangement region 512 at a plurality of positions different from each other (S22, S23, and S24). Therefore, a time it takes for the uncured resin 7s to spread throughout the motor rotor arrangement region 512 can be shortened in comparison with a case where the uncured resin 7s is injected at one position. The end plate 6 is attached after the uncured resin 7s is injected (S26). When the end plate 6 is attached, the end plate 6 is pressed against the liquid surface 73k of the uncured resin 7s so that the uncured resin 7s is exposed through the first end plate through-hole 6P1 and the second end plate through-hole 6P2. The uncured resin 7s exposed through the first end plate through-hole 6P1 and the second end plate through-hole 6P2 by being pressed by the end plate 6 means that the end plate rear surface 6b is in contact with the uncured resin 7s. Therefore, the motor 1 which easily releases heat to the outside can be produced in a short time.

In the injection step (S22, S23, and S24) of the method illustrated in FIG. 8, the uncured resin 7s is continuously injected while the housing 5 and a device for supplying the uncured resin 7s are being relatively rotated around the axis A of the housing 5. According to such a step as well, a time it takes for the uncured resin 7s to spread throughout the motor rotor arrangement region 512 can be shortened.

The injection step (S22, S23, S24) of the second method for manufacturing the motor 1 includes a step (S22) of injecting a predetermined amount of the uncured resin 7s into the first portion 40a of the coil 4B and a step (S23) of injecting a predetermined amount of the uncured resin 7s into the second portion 40b of the coil 4B, which is different from the first portion 40a. According to such a step as well, a time it takes for the uncured resin 7s to spread throughout the motor rotor arrangement region 512 can be shortened.

The motor 1 includes the motor stator 4 around which the coil 4B is wound, the motor rotor 3 which is enclosed by the motor stator 4 and rotates together with a shaft, the housing 5 which receives the motor stator 4 and the motor rotor 3 through the housing opening 51h and forms the motor rotor arrangement region 512 for accommodating the received motor stator 4, the end plate 6 attached to the housing opening 5h, and the resin part 7 filled in the motor rotor arrangement region 512. The resin part 7 is in contact with the coil 4B and is in contact with the end plate 6, and the end plate 6 includes a plurality of the end plate through-holes 6P through which the resin part 7 is exposed.

The resin part 7 of the motor 1 is in contact with the coil 4B and is in contact with the end plate 6. According to such a configuration, it may reliably form a path for transfer of heat from the coil 4B to the end plate 6 via the resin part 7. As a result, heat can be preferably released to the outside.

In the motor 1, the resin part exposed surface 73s exposed through the plurality of end plate through-holes 6P is positioned between the opening edge 6bs on the end plate rear surface 6b side and the opening edge 62as on the end plate main surface 6a side. According to such a configuration, it may achieve a structure in which the resin part 7 is reliably in contact with the end plate rear surface 6b.

The end plate 6 of the motor 1 includes the annular inner peripheral cylindrical portion 63 including the end plate shaft insertion hole 6H through which the shaft 2 is inserted, the annular outer peripheral cylindrical portion 61 surrounding the inner peripheral cylindrical portion 63 in a circumferential direction and having an inner diameter larger than an outer diameter of the inner peripheral cylindrical portion 63, and a plurality of spokes 62 disposed at intervals around the axis A of the shaft 2 to connect the inner peripheral cylindrical portion outer peripheral surface 63d of the inner peripheral cylindrical portion 63 to the outer peripheral annular portion inner peripheral surface 611c of the outer peripheral cylindrical portion 61. Each of the plurality of end plate through-holes 6P is a region interposed between a pair of the spokes 62 adjacent to each other around the axis A of the shaft 2. An end surface 63x (FIG. 2) of the inner peripheral cylindrical portion 63 protrudes from the spokes 62 (e.g., first connecting portion 62x) along an axial direction of the shaft 2. According to such a structure, it may suppress adhesion of the uncured resin 7s to the end surface of the inner peripheral cylindrical portion 63 and thus it may use the end surface of the inner peripheral cylindrical portion 63 as an installation surface for a component.

In short, each of the plurality of end plate through-holes 6P is configured by the spokes 62. Each of the plurality of end plate through-holes 6P may be connected by a groove one-step lower than an installation surface for other components so that the resin portion 7 may adhere thereto. Examples of the installation surface for other components are the outer peripheral annular portion main surface 611a and the inner peripheral cylindrical portion main surface 63a. Furthermore, a dedicated surface for contact with a masking jig may be provided so that the liquid surface 73k of the uncured resin 7s in a foamed state does not adhere to the installation surface for other components. Examples of the specific surface for contact with the masking jig are the outer peripheral step portion 613 and the inner peripheral step portion 633.

The number of openings provided in the end plate 6 may be plural. The resin part 7 may be formed of mutually different kinds of resin materials. For example, casting is performed by means of a resin having high thermal conductivity until the coil 4B is hidden. Thereafter, casting may be performed by means of resin having low viscosity and medium thermal conductivity in the vicinity of the end plate 6. According to such a configuration, both control of the liquid surface 73k and thermal conductivity can be achieved. After casting resin without mounting the end plate, the end plate may be mounted before the resin is cured.

It is to be understood that not all aspects, advantages and features described herein may necessarily be achieved by, or included in, any one particular example. Indeed, having described and illustrated various examples herein, it should be apparent that other examples may be modified in arrangement and detail.

Some additional examples are disclosed as follows, with continued reference to the drawings for convenience of description.

Some additional examples are disclosed as follows, with continued reference to the drawings for convenience of description. An example method for manufacturing a motor may includes attaching an end plate (6) to a housing (5) accommodating a stator (4) around which a coil (4B) is wound, the end plate (6) including a first end plate through-hole (6P1) and a second end plate through-hole (6P2); injecting, after attaching the end plate (6) to the housing (5), a first amount of an uncured resin (7s) into a stator arrangement region (511) inside the housing (5), in which the stator (4) and the coil (4B) are located, through the first end plate through-hole (6P1); and injecting, after attaching the end plate (6) to the housing (5), a second amount of the uncured resin (7s) into the stator arrangement region (511) through the second end plate through-hole (6P2).

In some examples, the injection of the first amount of the uncured resin (7s) and the injection of the second amount of the uncured resin (7s) may be repeated so that the uncured resin (7s) is exposed through at least one of the first end plate through-hole (6P1) and the second end plate through-hole (6P2).

In some examples, the coil (4B) may include a first coil portion (40a) and a second coil portion (40b), which is different from the first coil portion (40a), the first coil portion (40a) may be visually observable from outside of the housing (5) through the first end plate through-hole (6P1), and the second coil portion (40b) may be visually observable from outside of the housing (5) through the second end plate through-hole (6P2).

In some examples, the method may comprise checking whether a liquid surface (73k) of the uncured resin (7s) has reached a prescribed position by visually observing the position of the liquid surface (73k) through at least one of the first end plate through-hole (6P1) and the second end plate through-hole (6P2).

In some examples, the injection of the first amount of the uncured resin (7s) and the second amount uncured resin (7s) may be stopped when the liquid surface (73k) reaches the prescribed position.

In some examples, the second amount of the uncured resin (7s) may be injected into the stator arrangement region (511) after the injection of the first amount of the uncured resin (7s).

In some examples, the method may comprise placing the housing (5), to which the end plate (6) is attached, into a vacuum chamber (102). The first amount of the uncured resin (7s) and the second amount of the uncured resin (7s) may be injected by vacuum filling.

In some examples, the housing (5) to which the end plate (6) may be attached is heated while at least one of the first amount of the uncured resin (7s) and the second amount of the uncured resin (7s) is being injected.

In some examples, the first amount of the uncured resin (7s) may be injected such that a liquid surface (73k) of the uncured resin (7s) in the stator arrangement region (511) reaches the first end plate through-hole (6P1).

In some examples, the first amount of the uncured resin (7s) and the second amount of the uncured resin (7s) may be injected such that a liquid surface (73k) of the uncured resin (7s) in the stator arrangement region (511) reaches the first end plate through-hole (6P1) and the second end plate through-hole (6P2).

In some examples, the first amount of the uncured resin (7s) may be injected such that an exposed surface (73s) of the first amount of the uncured resin (7s) is located inside the first end plate through-hole (6P1), and the second amount of the uncured resin (7s) may be injected such that an exposed surface (73s) of the second amount of the uncured resin (7s) is located inside the second end plate through-hole (6P2).

Additionally, an example method for manufacturing a motor (1) including a housing (5) with an opening (51h) comprises: injecting uncured resin (7s) into a stator arrangement region (511) of the housing (5), in which a stator (4) and a coil (4B) are located, through the opening (51h) of the housing (5); and attaching an end plate (6) having a through-hole (6P1, 6P2), after the uncured resin (7s) has been injected into the stator arrangement region (511), so that the end plate (6) covers the opening (51h) of the housing (5). When attaching the end plate (6), the end plate (6) is pressed against a liquid surface (70) of the uncured resin (7s) so that the uncured resin (7s) is exposed through the through-hole (6P1, 6P2).

In some examples, the uncured resin (7s) may be injected into a plurality of different areas within the stator arrangement region (511) through the opening (51h).

In some examples, the through-hole may include a first end through-hole (6P1) and a second end through-hole (6P1) spaced apart from the first end through-hole (6P1). When attaching the end plate (6), the end plate (6) may pressed against a liquid surface of the uncured resin (7s) so that the uncured resin (7s) is exposed through at least one of the first end through-hole (6P1) and the second end through-hole (6P2).

In some examples, the housing (5) may include a tubular portion having an axis (A). The uncured resin (7s) may be continuously injected from the opening (51h) while the uncured resin (7s) and the housing (5) are rotated relative to each other about the axis (A).

In some examples, the coil (4B) may include a first coil portion (40a) and a second coil portion (40b), which is different from the first coil portion (40a). A predetermined amount of the uncured resin (7s) may be injected into the first coil portion (40a), and a predetermined amount of the uncured resin (7s) may be injected into the second coil portion (40b).

Additionally, an example motor (1) comprises: a stator (4) around which a coil (4B) is wound; a rotor (3) enclosed by the stator (4) and rotating together with a shaft (2); a housing (5) in which the stator (4) and the rotor (3) are accommodated, the housing (5) including an opening (51h) and a stator arrangement region (511) which accommodates the stator (4); an end plate (6) attached to the housing (5) and covering the opening (51h); and a resin part (7) filled in the stator arrangement region (511). The resin part (7) is in contact with the coil (4B) and the end plate (6), and the end plate (6) includes a plurality of end plate through-holes (6B1, 6B2) through which the resin part (7) is exposed.

In some examples, wherein the plurality of end plate through-holes may include a first end plate through-hole (6B1) and a second end plate through-hole (6B2). The end plate (6) may include a rear surface (6b) facing the housing (5) and a main surface (6a) opposite to the rear surface (6b). A rear-side opening edge (6bs) of the first end plate through-hole (6B1) may be located on the rear surface (6b), and a main-side opening edge (62as) of the first end plate through-hole (6B1) may be located on the main surface (6a). An exposed surface (73s) of the resin part (7) exposed through the first end plate through-hole (6B1) may be located between the rear-side opening edge (6b) and the main-side opening edge (62as).

In some examples, the end plate (6) may include: an annular inner cylindrical portion (63) including a shaft hole (6H) through which the shaft (2) is inserted; an annular outer cylindrical portion (61) surrounding the inner cylindrical portion (63) in a circumferential direction and having an inner diameter larger than an outer diameter of the inner cylindrical portion (63); and a first connecting portion (62x) and a second connecting portion (62y) that are spaced apart in the circumferential direction, the first connecting portion (62x) and the second connecting portion (62y) connecting an outer peripheral surface of the inner cylindrical portion (61) to an inner peripheral surface of the outer cylindrical portion (63).

In some examples, the end plate through-hole (6B1) may be formed between the first connecting portion (62x) and the second connecting portion (62y). The inner cylindrical portion (63) may include an end surface (63x) that is spaced away from both the first connecting portion (62x) and the second connecting portion (62y) in an axial direction of the shaft.

What is claimed is:

1. A method for manufacturing a motor comprising:
attaching an end plate to a housing accommodating a stator around which a coil is wound, the end plate including a first end plate through-hole and a second end plate through-hole;
injecting, after attaching the end plate to the housing, a first amount of an uncured resin into a stator arrangement region inside the housing, in which the stator and the coil are located, through the first end plate through-hole; and
injecting, after attaching the end plate to the housing, a second amount of the uncured resin into the stator arrangement region through the second end plate through-hole.

2. The method according to claim 1, wherein the injection of the first amount of the uncured resin and the injection of the second amount of the uncured resin are repeated so that the uncured resin is exposed through at least one of the first end plate through-hole and the second end plate through-hole.

3. The method according to claim 1,
wherein the coil includes a first coil portion and a second coil portion, which is different from the first coil portion,
wherein the first coil portion is visually observable from outside of the housing through the first end plate through-hole, and
wherein the second coil portion is visually observable from outside of the housing through the second end plate through-hole.

4. The method according to claim 1, further comprising checking whether a liquid surface of the uncured resin has reached a prescribed position by visually observing the position of the liquid surface through at least one of the first end plate through-hole and the second end plate through-hole.

5. The method according to claim 4, wherein the injection of the first amount of the uncured resin and the second amount of the uncured resin is stopped when the liquid surface reaches the prescribed position.

6. The method according to claim 1, wherein the second amount of the uncured resin is injected into the stator arrangement region after the injection of the first amount of the uncured resin.

7. The method according to claim 1, further comprising placing the housing, to which the end plate is attached, into a vacuum chamber,
wherein the first amount of the uncured resin and the second amount of the uncured resin are injected by vacuum filling.

8. The method according to claim 1, wherein the housing to which the end plate is attached is heated while at least one of the first amount of the uncured resin and the second amount of the uncured resin is being injected.

9. The method according to claim 1, wherein the first amount of the uncured resin is injected such that a liquid surface of the uncured resin in the stator arrangement region reaches the first end plate through-hole.

10. The method according to claim 1, wherein the first amount of the uncured resin and the second amount of the uncured resin are injected such that a liquid surface of the uncured resin in the stator arrangement region reaches the first end plate through-hole and the second end plate through-hole.

11. The method according to claim 10,
wherein the first amount of the uncured resin is injected such that an exposed surface of the first amount of the uncured resin is located inside the first end plate through-hole, and
wherein the second amount of the uncured resin is injected such that an exposed surface of the second amount of the uncured resin is located inside the second end plate through-hole.

12. A method for manufacturing a motor including a housing with an opening, the method comprising:
injecting uncured resin into a stator arrangement region of the housing, in which a stator and a coil are located, through the opening of the housing; and
attaching an end plate having a through-hole, after the uncured resin has been injected into the stator arrangement region, so that the end plate covers the opening of the housing,
wherein, when attaching the end plate, the end plate is pressed against a liquid surface of the uncured resin so that the uncured resin is exposed through the through-hole.

13. The method according to claim 12, wherein the uncured resin is injected into a plurality of different areas within the stator arrangement region through the opening.

14. The method according to claim 12,
wherein the through-hole includes a first end through-hole and a second end through-hole spaced apart from the first end through-hole, and
wherein, when attaching the end plate, the end plate is pressed against a liquid surface of the uncured resin so that the uncured resin is exposed through at least one of the first end through-hole and the second end through-hole.

15. The method according to claim 14,
wherein the housing includes a tubular portion having an axis,
wherein the uncured resin is continuously injected from the opening while the uncured resin and the housing are rotated relative to each other about the axis.

16. The method according to claim 14,
wherein the coil includes a first coil portion and a second coil portion, which is different from the first coil portion,
wherein a predetermined amount of the uncured resin is injected into the first coil portion, and
wherein a predetermined amount of the uncured resin is injected into the second coil portion.

17. A motor comprising:
a stator around which a coil is wound;
a rotor enclosed by the stator and rotating together with a shaft;
a housing in which the stator and the rotor are accommodated, the housing including an opening and a stator arrangement region which accommodates the stator;
an end plate attached to the housing and covering the opening; and
a resin part filled in the stator arrangement region,
wherein the resin part is in contact with the coil and the end plate, and
the end plate includes a plurality of end plate through-holes through which the resin part is exposed.

18. The motor according to claim 17,
wherein the plurality of end plate through-holes includes a first end plate through-hole and a second end plate through-hole,
wherein the end plate includes a rear surface facing the housing and a main surface opposite to the rear surface,
wherein a rear-side opening edge of the first end plate through-hole is located on the rear surface, and a main-side opening edge of the first end plate through-hole is located on the main surface, and
wherein an exposed surface of the resin part exposed through the first end plate through-hole is located between the rear-side opening edge and the main-side opening edge.

19. The motor according to claim 17, wherein the end plate includes:
an annular inner cylindrical portion including a shaft hole through which the shaft is inserted;
an annular outer cylindrical portion surrounding the inner cylindrical portion in a circumferential direction and having an inner diameter larger than an outer diameter of the inner cylindrical portion; and
a first connecting portion and a second connecting portion that are spaced apart in the circumferential direction, the first connecting portion and the second connecting portion connecting an outer peripheral surface of the inner cylindrical portion to an inner peripheral surface of the outer cylindrical portion.

20. The motor according to claim 19,
wherein the plurality of end plate through-holes includes a first end plate through-hole and a second end plate through-hole,
wherein the first end plate through-hole is formed between the first connecting portion and the second connecting portion, and
wherein the inner cylindrical portion includes an end surface that is spaced away from both the first connecting portion and the second connecting portion in an axial direction of the shaft.
